(19) United States
(12) Patent Application Publication
(10) Pub. No.: US 2025/0021851 A1
(43) Pub. Date: Jan. 16, 2025

(54) QUANTUM DATABASE UPDATE OPERATIONS SYSTEM

(71) Applicant: Abu Dhabi University, Abu Dhabi (AE)

(72) Inventors: Hichem El Euch, Abu Dhabi (AE); Mohammed Abdellatif Abdelaal Zidan, Assuit (EG); Montasir Yousouf Abdallah Qasymeh, Abu Dhabi (AE)

(73) Assignee: Abu Dhabi University, Abu Dhabi (AE)

(21) Appl. No.: 18/221,284

(22) Filed: Jul. 12, 2023

(51) Int. Cl. G06N 10/20

(52) U.S. Cl. CPC G06N 10/20

(57) ABSTRACT

A quantum method, includes initializing, by a quantum circuit, four registers, and two qubits in the quantum circuit. The quantum method further includes searching, by the quantum circuit, a uniform/weighted quantum database data states in register |QDB [symbol] that match criteria specified in register |qr [symbol] . The quantum method further includes applying, by the quantum circuit, an S operator. The quantum method further includes applying |M|+1-qubit Toffoli gate with |M| control qubits of the register |QDB [symbol] . The quantum method further includes removing an effect of the S operator. The quantum method further includes applying, by the quantum circuit, a number 2*|j| of 3-qubit Toffoli gates. The quantum method further includes updating marked data/records/basis states based on the applying a number |j| of other 3-qubit Toffoli gates. The quantum method further includes applying |M|+1 qubit Toffoli gates. The quantum method further includes applying controlled-S operator.

### BACKGROUND

Databases are used in various computing systems to store information. The main operations conducted on databases include insert operations, update operations, delete operations, and search operations. Currently, there is no effective systems that can provide such operations for databases associated with quantum computing systems.

### BRIEF DESCRIPTION OF DRAWINGS

FIG. 1 is a diagram of an example system;

FIG. 2 is a diagram of an example quantum circuit;

FIG. 3 is an example table;

FIG. 4 is an example of an example graph;

FIG. 5 is a diagram of an example graph;

FIG. 5 is a diagram of an example graph;

FIG. 6 is a diagram of an example computing device; and

FIG. 7 is a diagram of an example computing device.

### DETAILED DESCRIPTION OF PREFERRED EMBODIMENTS

The following detailed description refers to the accompanying drawings. The same reference numbers in different drawings may identify the same or similar elements.

Systems, devices, and/or methods described herein may provide for one or more quantum circuit systems that provided for quantum database (QDB) update operations. In embodiments, a particular quantum circuit may be an update circuit which performs update some of the basis state(s)/record(s)/data operations in quantum databases based on input criteria with complexity O(1). In embodiments, the particular quantum circuit may be used to update specific data/basis state(s)/record(s) from a uniform/weighted superposition QDB. In embodiments, the operation speed of the particular circuit is exponentially increased compared to previous systems.

Accordingly, the systems, devices, and/or methods described herein can be used to update a greater amount of data into a quantum database system, which cannot be achieved using non-quantum computers or other systems. In embodiments, the one or more quantum circuits provide for a more efficient update of information from one or more databases and can overcome issues of requiring more time associated with non-quantum systems. In embodiments, the update operation may have a database system that is integrated with Al/quantum-AI and information systems. Grover's algorithm, which is a quantum search algorithm, that reduces the search process within a database system of O(N^{½}) (where N is the number of items in the database), compared with traditional algorithms that need O(N). Thus, quantum computers have a significantly greater speed (such as a quadratic speed) to perform such search operations when compared to a non-quantum computer.

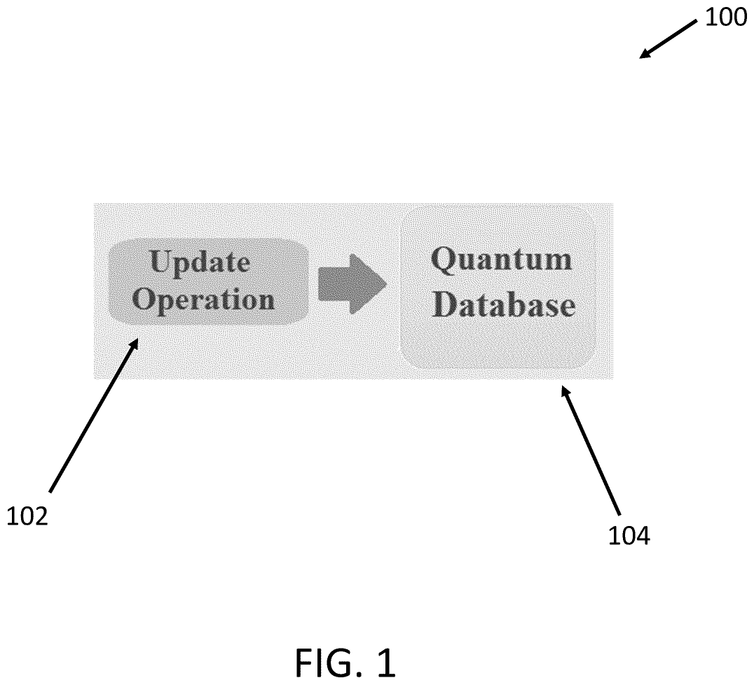

FIG. 1 shows an example diagram 100 of conducting an update operation for a quantum database system. In FIG. 1, update operation 102 is shown and may be used to interact with a quantum database (QDB) 104. In FIG. 1, database 104 may include one or more uniform/weighted quantum databases that may obtain information from one or more devices. As such, update operation 102 may be used to update information from quantum database 104 more efficiently than other systems.

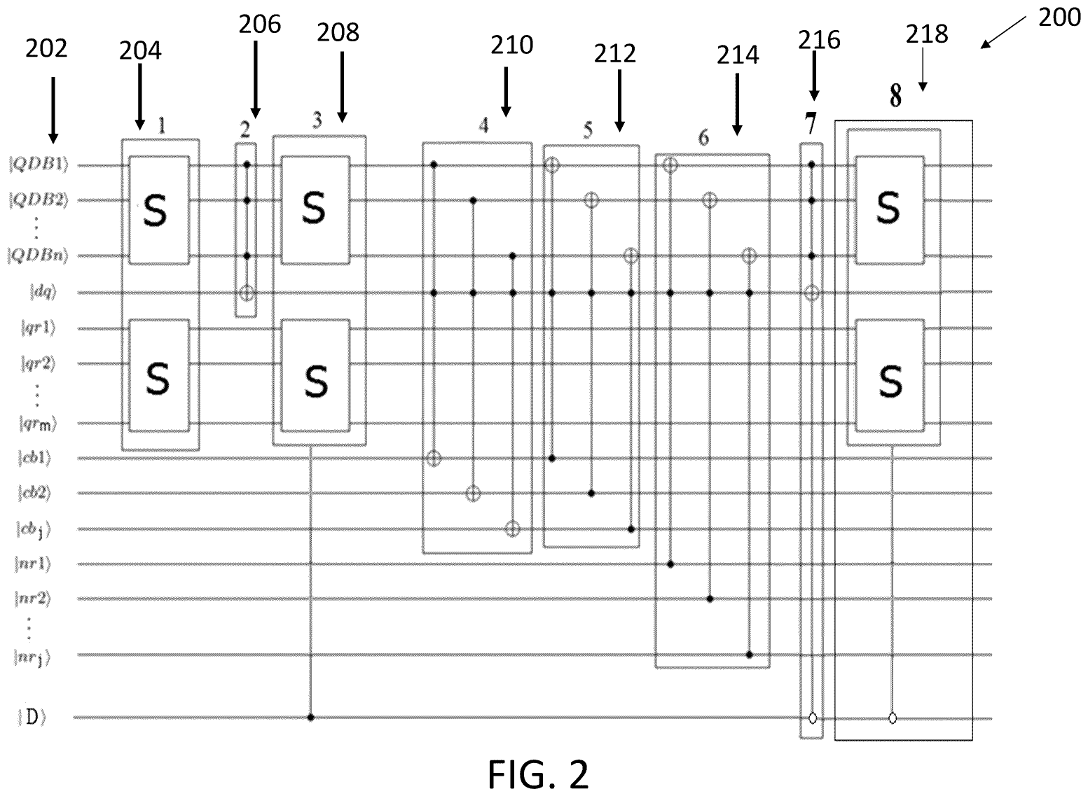

FIG. 2 is an example quantum circuit 200. In embodiments, quantum circuit 200 may be used to conduct an update for a set of records/basis states/data items, for an associated database (e.g., database 104), that satisfy predefined criteria. In embodiments, quantum circuit 200 consists of four registers: |QDB [symbol] , |qr [symbol] , |cb [symbol] , and |nr [symbol] ; the qubit |D [symbol] , and the qubit |dq [symbol] .

At step 202, quantum circuit 200 initializes the quantum state as |φ₀ [symbol] =|QDB,dq,cb,nr,D [symbol] . In embodiments, |QDB [symbol] is the register of size n qubits which stores a weighted/uniform quantum database data/basis states/records/items. In embodiments, |qr [symbol] is a register of size m qubits, where m≤n that is used to define the conditions/criteria which are used to determine the set/subset of data/basis states/records/items must be updated. In embodiments, |cb [symbol] is an ancillary register of size j≤n qubits which is initialized in the state |0 [symbol] ^{⊗j}. In embodiments, |nr [symbol] is a register of size j qubits, where j≤n that is used to define the new values which are used to over-written into the set/subset of |QDB [symbol] must be updated. In embodiments, |dq [symbol] is an ancillary qubit which is initialized by the state|0 [symbol] , the qubit |D [symbol] is initialized to state |0 [symbol] if it is not required to update the qubits of the register |QDB [symbol] that define the criteria/conditions that are define the data/basis state(s)/records/items which will be updated with new values. Conversely, the qubit |D [symbol] is initialized to state |1 [symbol] if it is required to update the qubits of the register |QDB [symbol] that define the criteria that are define the data/basis states/records/items.

At step 204, quantum circuit 200 searches for the quantum database data/basis state(s)/record(s)/item(s), in the register |QDB [symbol] , that matches the criteria/conditions specified by the quantum database user/information system application via the register |qr [symbol] , where the index of each qubit which its value is defined by the user/information system application is determined in the set M that contain the indices of qubits, that are used as criteria/conditions, in the register |QDB [symbol] such that |M|=m. In embodiments, by applying the S operator between the query register |qᵣ [symbol] and the |QDB [symbol] , register as

$$\vert {φ}_{1} 〉 = {S}_{{q}_{{r}_{g}} {QDB}_{h}} \vert {φ}_{0} 〉 = {\prod }_{g} {CNOT}_{{q}_{{r}_{g}} {QDB}_{h}} {NOT}_{{QDB}_{h}} \vert {φ}_{0} 〉 , \\ g = 1 , 2 , … , m , and h ∈ M .$$

In embodiments, the search for the matched data/record(s)/basis state(s)/item(s) is performed by applying the S operator between each qubit |qr_{g} [symbol] has an index in the set M of the registers |qr [symbol] , as a control qubit, and the corresponding qubit |QDBₕ [symbol] as a target qubit.

At step 206, quantum circuit 200 applies a |M|+1-qubit Toffoli gate with |M| control qubits of the register |QDB [symbol] which have indexes specified by the set M, and the target qubit is |dq [symbol] .

$$\vert {φ}_{2} 〉 = {T}_{\{ {QDB}_{h ∈ M \} dq}}^{\vert M \vert} \vert {φ}_{1} 〉 .$$

In embodiments, the Toffli-gate is applied to mark the data/basis state(s)/record(s)/item(s) which match the criteria/conditions defined by the register |qr [symbol] to update them in step 6 (step 214).

At step 208, quantum circuit 200, the controlled-S operator is applied to remove the effect of the S operator applied in Step 204 by:

$$\vert {φ}_{3} 〉 = C - {S}_{D {q}_{{r}_{g}} {QDB}_{h}} \vert {φ}_{2} 〉 ,$$

the control qubit of the S operator is |D [symbol] which activates the S operator when the state of the qubit |D [symbol] is |1 [symbol] . The state of the qubit |D [symbol] is initialized to the state |1 [symbol] when the data/basis state(s)/record(s)/item(s) that are required to be updated, contain the criteria/condition data.

At step 210, quantum circuit 200 applies a number |j| of 3-qubit Toffoli gates as follows:

$$\vert {φ}_{4} 〉 = {\prod }_{\begin{matrix}i ∈ j \\ k = 1\end{matrix}}^{\vert j \vert} {T}_{{QDB}_{i} {dqcb}_{k}}^{2} \vert {φ}_{3} 〉 .$$

In embodiments, at step 210, quantum circuit 200 writes the value of each qubit i ϵ j into the corresponding qubit of the ancillary register |cb [symbol] by applying the number |j| of 3-qubit Toffoli gates, each gate is controlled by the qubit |QDBᵢ [symbol] ), |dq [symbol] , and the target qubit is |cbₖ

[symbol] , where i ϵ j, and k=1,2, . . . , |j|. The set j contains the indices of the qubits which are needed to be updated in the register |QDB [symbol] .

At step 212, quantum circuit 200 applies a number |j| of 3-qubit Toffoli gates as follows:

$$\vert {φ}_{5} 〉 = {\prod }_{\begin{matrix}k = 1 \\ i ∈ j\end{matrix}}^{\vert j \vert} {T}_{{cb}_{k} dq {QDB}_{i}}^{2} \vert {φ}_{4} 〉 .$$

In embodiments, quantum circuit 200, at step 212, converts the state of each qubit that has an index defined by the set j, and marked by entanglement via the qubit |dq [symbol] , to the state |0) by applying a number |j| of 3-qubit Toffoli gates, each gate is controlled by the qubits |cbₖ [symbol] , |dq [symbol] , and the target qubit is |QDBᵢ [symbol] . In embodiments, at the end, number |j| of qubits which have indices defined by the set j of the register |QDB [symbol] are transformed individually into the state |0 [symbol] ; and these states are entangled with the qubit |dq [symbol] .

At step 214, quantum circuit 200 applies number |j| of 3-qubit Toffoli gates as follows:

$$\vert {φ}_{7} 〉 = {\prod }_{i ∈ j}^{\vert j \vert} {T}_{{nr}_{i} dq {QDB}_{i}}^{2} \vert {φ}_{6} 〉 .$$

In embodiments, quantum circuit 200, at step 214, is used to update data/basis state(s)/item(s)/records(s) of the QDB with the new values that are marked in the register |QDB [symbol] .

At step 216, quantum circuit 200 applies |M|+2-qubit Toffoli gate as follows:

$$\vert {φ}_{7} 〉 = {T}_{D \{ {QDB}_{h} \} dq}^{\vert M \vert + 1} \vert {φ}_{6} 〉 , where h ∈ M .$$

In embodiments, quantum circuit 200, at step 216, this gate flips the state of the target qubit |dq [symbol] when each qubit of the number |M| qubits of the register |QDBᵢ [symbol] (which are determined by the indices defined by the set M) are in the state |1 [symbol] , and the state of the qubit |D [symbol] is |0 [symbol] , and the target qubit is |dq [symbol] . This step removes the effect of step 2 (step 206) when it is not required to update the state of the qubits of the register |QDB [symbol] that are define the criteria/conditions data for updating the data/basis state(s)/item(s)/record(s). In embodiments, quantum circuit 200, at step 216, is used to remove the entanglement/marking between the register |QDB [symbol] , and the qubit |dq [symbol] .

At step 218, quantum circuit 200 the controlled-S operator is applied to remove the effect of the S operator applied in Step 204 by:

$$\vert {φ}_{8} 〉 = C - {S}_{D {q}_{g} {QDB}_{h}} \vert {φ}_{7} 〉 .$$

the control qubit of the S operator is |D [symbol] which activates the S operator when the state of the qubit |D [symbol] is |0 [symbol] . This step removes the effect of step 1 (step 204) when it is not required to update the state of the qubits of the register |QDB [symbol] that are define the criteria/conditions data for updating the data/basis state(s)/records.

Accordingly, performance of quantum circuit 200 is exponentially faster than when compared to traditional algorithms. Also, quantum circuit 200 can be used to update a set of data/basis state(s)/records/item(s) with different values in a uniform/weighted superposition of the QDB at the same time which cannot achieve via traditional computers.

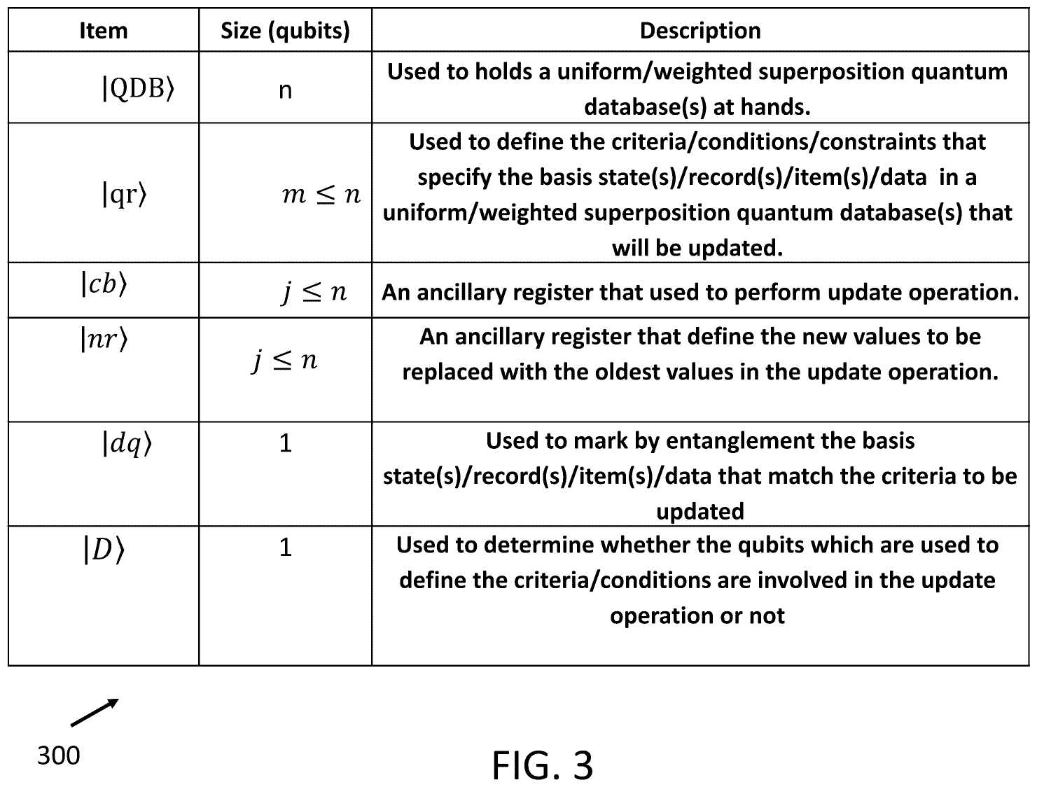

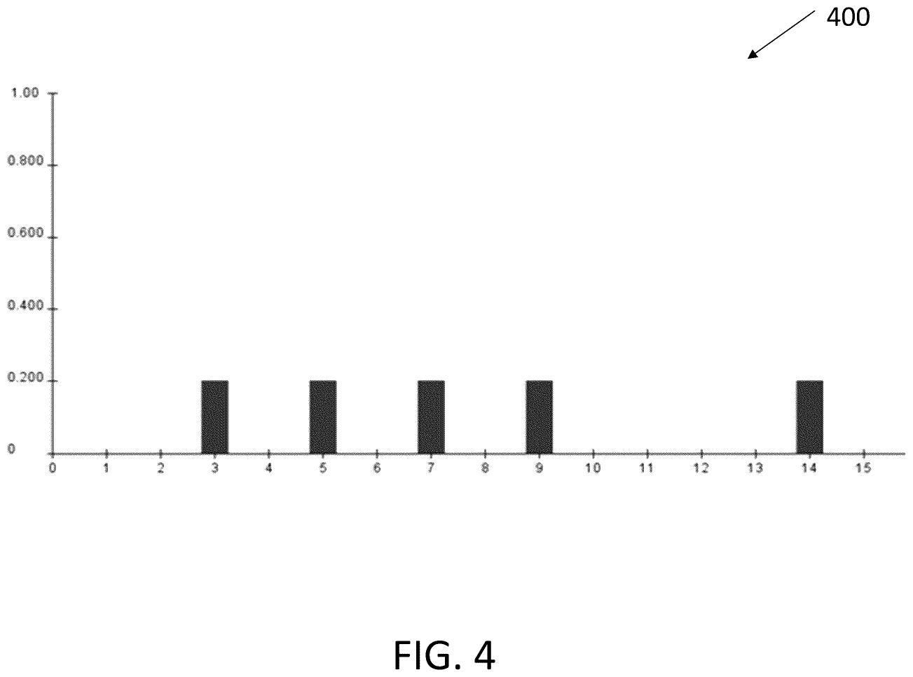

In embodiments, the quantum update circuit (e.g., quantum circuit 200) may occur in two scenarios. In embodiments, in a first scenario, we realize a partial update for a subset of qubits in a set of data, in a given quantum database (e.g., 104 in FIG. 1), that satisfy a given criteria. FIG. 3 is an example table 300 that describes each of the features described in FIG. 2. In embodiments, in a second scenario, it is required to realize total update for all qubits in for a set of data that satisfy a given criteria. In the first scenario, suppose that it is required to update the last two qubits to the state |00 [symbol] for the set of data which satisfy the criterion such that the first two qubits are |01 [symbol] in the database associated with FIG. 4.

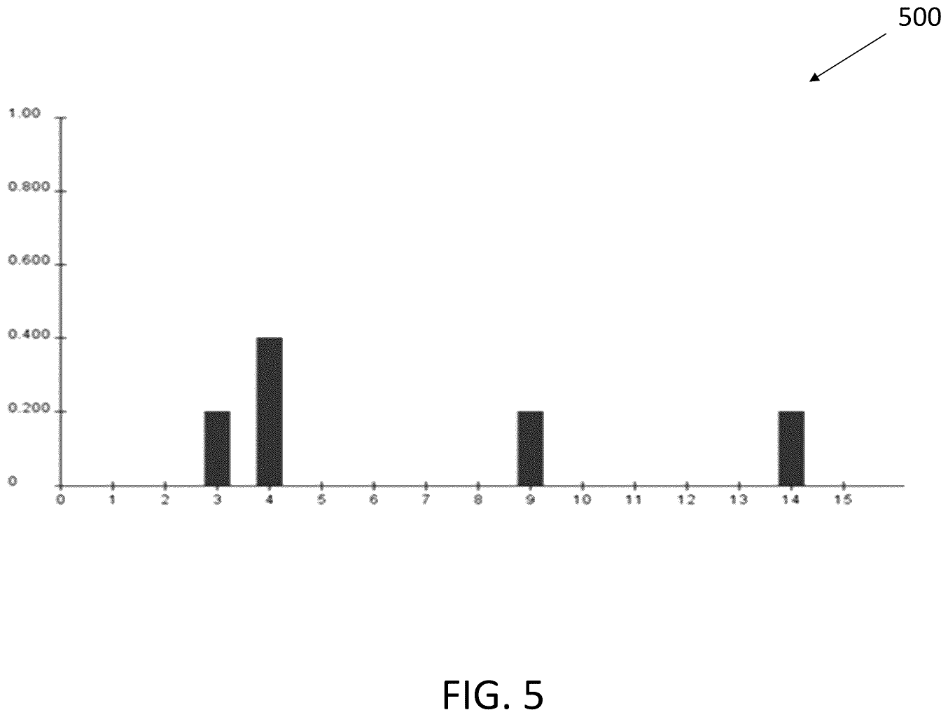

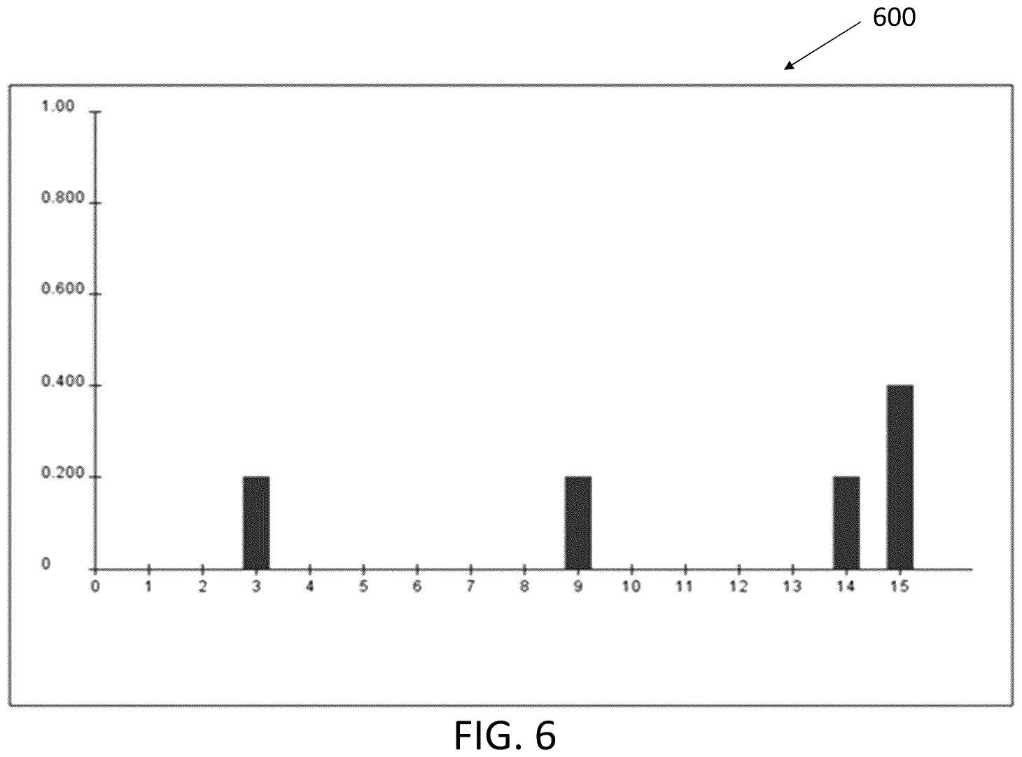

For FIG. 4, it is expected that the states |5 [symbol] =|0101 [symbol] , and |7 [symbol] =|0111 [symbol] are updated to the state |4 [symbol] =|0100 [symbol] in the quantum database. After applying the proposed update circuit via a Java simulator, the graphical results are shown in FIG. 5.

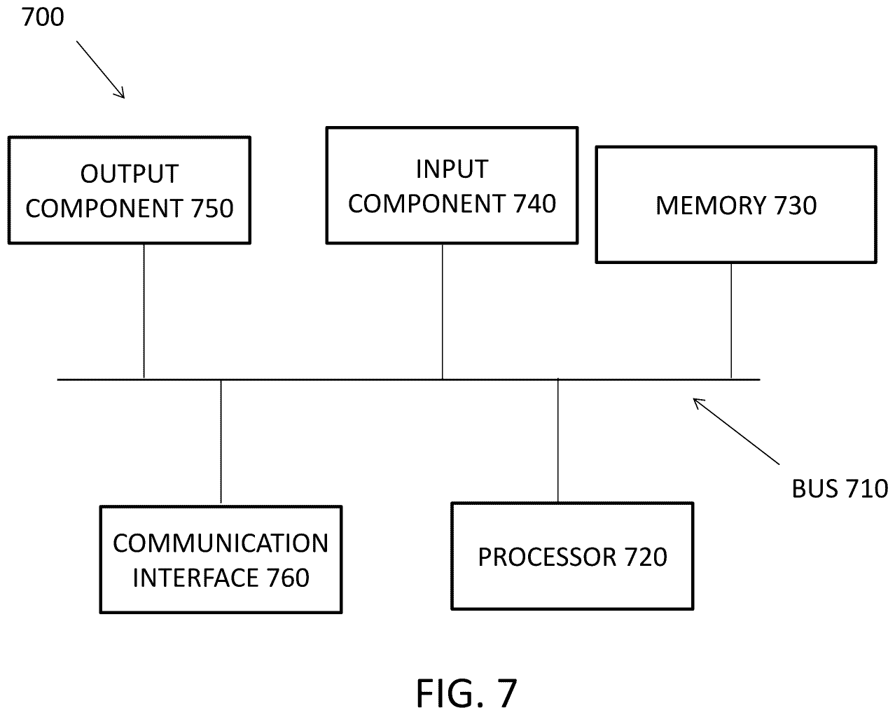

In embodiments, in the second scenario, to update the all qubits to be in the state |1111 [symbol] for the set of data which satisfy the criterion such that the first two qubits are |01 [symbol] in the database shown in FIG. 4. Thus, it is expected that the states |5 [symbol] =|0101 [symbol] , and |7 [symbol] =|0111 [symbol] are updated to the state |15 [symbol] =|1111 [symbol] in the quantum database. After applying the proposed update circuit via the simulator the results are depicted in FIG. 6.

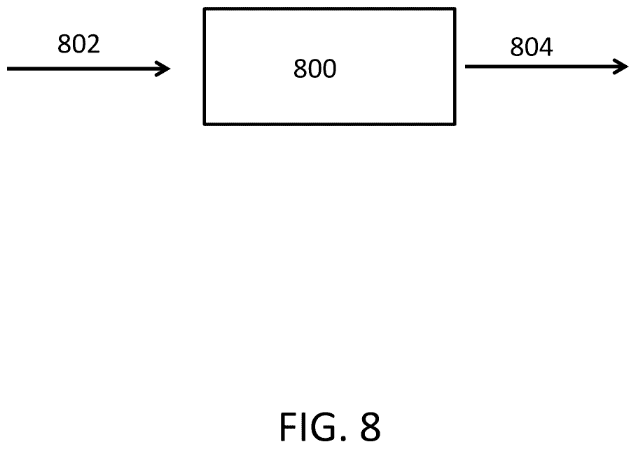

FIG. 7 is a diagram of example components of a device 700. Device 700 may correspond to a computing device, such as devices that may use database 104. As shown in FIG. 7, device 700 may include a quantum bus 710, a quantum processor 720, a quantum memory 730, quantum input component 740, quantum output component 750, and a communications interface 760. In other implementations, device 700 may contain fewer components, additional components, different components, or differently arranged components than depicted in FIG. 7. Additionally, or alternatively, one or more components of device 700 may perform one or more tasks described as being performed by one or more other components of device 700.

Quantum bus 710 may include a path that permits communications among the components of device 700. Quantum processor 720 may include one or more processors, microprocessors, and/or processing logic (e.g., a field programmable gate array (FPGA), quantum teleportation devices, quantum communication devices, quantum computing circuits, quantum encryption applications and/or an application specific integrated circuit (ASIC)) that interprets and executes instructions. Input component 740 may include a mechanism that permits a user to convert classical information to quantum input information to device 700, such as a quantum circuit, a quantum-based application, a keyboard, a keypad, a button, a switch, voice command, etc. Quantum output component 750 may include a mechanism that outputs information and transforms quantum information to classical information to be provided to the user, such as a display, a speaker, one or more light emitting diodes (LEDs), etc.

Quantum communications interface 760 may include any transceiver-like mechanism that enables device 700 to communicate with other devices and/or systems. For example, communications interface 760 may include an Ethernet interface, an optical interface, a coaxial interface, a wireless interface, or the like and quantum-to-classical and vice versa unit.

In another implementation, quantum communications interface 760 may include, for example, a transmitter that may convert baseband signals from quantum processor 720 to radio frequency (RF) signals and/or a receiver that may convert RF signals to baseband signals. Alternatively, communications interface 760 may include a transceiver to perform functions of both a transmitter and a receiver of wireless communications (e.g., radio frequency, infrared, visual optics, quantum wireless, quantum channels, quantum fiber optics, quantum teleportation, quantum communication devices/networks, quantum encryption devices, etc.), wired communications (e.g., conductive wire, twisted pair cable, coaxial cable, transmission line, fiber optic cable, waveguide, single-photon channels, multi-photon channels, etc.), or a combination of wireless and wired communications.

Communications interface 760 may connect to an antenna assembly (not shown in FIG. 7) for transmission and/or reception of the RF signals, and/or quantum channels. The antenna assembly may include one or more antennas to transmit, quantum channels and/or receive RF signals over the air. The antenna assembly may, for example, receive RF signals and/or quantum information from communications interface 760 and transmit the RF signals over the air, and receive RF signals over the air and provide the RF signals to communications interface 760. In one implementation, for example, communications interface 760 may communicate with a network (e.g., a wireless network, quantum network, quantum channel, wired network, Internet, quantum internet, etc.). In embodiments, an antenna may be implemented by quantum teleportation protocols, quantum communication protocols and/or quantum encryption protocols.

As will be described in detail below, device 700 may perform certain operations. Device 600 may perform these operations in response to processor 720 executing software instructions (e.g., computer program(s), quantum computing circuit, quantum teleportation, etc.) contained in a computer-readable medium/quantum-based computing, such as quantum memory 730, a secondary storage device (e.g., hard disk, CD-ROM, etc.), or other forms of RAM or ROM. A computer-readable medium may be defined as a non-transitory memory device. A memory device may include space within a single physical memory device or spread across multiple physical memory devices. The software instructions may be read into quantum memory 730 from another computer-readable medium or from another device. The software instructions contained in quantum memory 730 may cause quantum processor 720 to perform processes described herein. Alternatively, hardwired circuitry may be used in place of or in combination with software instructions to implement processes described herein. Thus, implementations described herein are not limited to any specific combination of hardware circuitry and software.

FIG. 8 is an example diagram of a computing device. FIG. 8 describes device 800, input 802, and output 804. In embodiments, device 800 may a computing device with features/structures similar to that described in FIG. 8. In embodiments, device 800 may be a computing device that is part of a laptop, desktop, tablet, smartphone, quantum computer, quantum computing device, quantum communication device, quantum internet device, and/or any other device. In embodiments, device 800 may include database 104, similar to that described in the above figures.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

While various actions are described as selecting, displaying, transferring, sending, receiving, generating, notifying, and storing, it will be understood that these example actions are occurring within an electronic computing, electronic networking, quantum database, quantum computing and/or quantum networking environment and may require one or more computing devices, as described in FIG. 7 or 8 to complete such actions. Furthermore, it will be understood that these various actions can be performed by using a touch screen on a computing device (e.g., touching an icon, swiping a bar or icon), using a keyboard, a mouse, or any other process for electronically selecting an option displayed on a display screen to electronically communicate with other computing devices, quantum computer, cloud, quantum communication devices, and/or quantum networks. Also, it will be understood that any of the various actions can result in any type of electronic information and/or quantum information to be displayed in real-time and/or simultaneously on multiple user devices. Any electronic graphs and/or quantum information may be generated by a computing device, such as device 600, and displayed via a graphical user device (GUI) or cloud environment.

No element, act, or instruction used in the present application should be construed as critical or essential unless explicitly described as such. Also, as used herein, the article “a” is intended to include one or more items and may be used interchangeably with “one or more.” Where only one item is intended, the term “one” or similar language is used. Further, the phrase “based on” is intended to mean “based, at least in part, on” unless explicitly stated otherwise.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A quantum method, comprising:
initializing, by a quantum circuit, four registers and two qubits in the quantum circuit;
searching, by the quantum circuit, database data in register |QDB [symbol] that matches criteria specified in register |qr [symbol] ;
applying, by the quantum circuit, an S operator;
applying, by the quantum circuit, [M]+1-qubit Toffoli gate with |M| control qubits of the register |QDB [symbol] ;
removing, by the quantum circuit, an effect of the controlled-S operator; and/or applying, by the quantum circuit, a number 2*|j| of 3-qubit Toffoli gates;
updating, by the quantum circuit, marked data/records/basis states based on applying a number |j| of 3-qubit Toffoli gates;
applying, by the quantum circuit, |M|+2 qubit Toffoli gate; and
applying, by the quantum circuit, an effect of the controlled-S operator;

2. The quantum method of claim 1, wherein the registers include |QDB [symbol] , |dq [symbol] , |qᵣ [symbol] , |nᵣ [symbol] , |cb [symbol] , and |D [symbol] .

3. The quantum method of claim 2, wherein the registers |cb [symbol] is an ancillary register of a particular size.

4. The quantum method of claim 2, wherein the register |qᵣ [symbol] is a quantum register that includes criteria to specify quantum data for updating.

5. The quantum method of claim 4, wherein the applying the |M|+1-qubit Toffoli gate includes entangling data/records/basis states/items which match criteria defined by the register |qᵣ [symbol] for update operation.

6. The quantum method of claim 1, wherein the applying the |j| of 3-qubit Toffoli gates includes:
$$\vert {φ}_{4} 〉 = {\prod }_{\begin{matrix}i ∈ j \\ k = 1\end{matrix}}^{\vert j \vert} {T}_{{QDB}_{i} {dqcb}_{k}}^{2} \vert {φ}_{3} 〉 .$$

7. The quantum method of claim 1, wherein the applying the |j|+1 qubit Toffoli gates includes:
$$\vert {φ}_{7} 〉 = {T}_{D \{ {QDB}_{h} \} dq}^{\vert M \vert + 1} \vert {φ}_{6} 〉 , where h ∈ M .$$

8. The quantum method of claim 7, wherein the applying the |j|+1 qubit Toffoli gates flip a state of a target qubit |dq [symbol] when each qubit of the number |M| of the qubits of the register |QDBᵢ [symbol] are in the state |1 [symbol] .

9. The quantum method of claim 8, wherein the applying the |j|+1 qubit Toffoli gates removes entanglement between the register |QDB [symbol] and the qubit |dq [symbol] .

10. The quantum method of claim 7, further comprising:
applying the controlled S operator to remove the effect of the S operator by
$$\vert {φ}_{8} 〉 = C - {S}_{D {q}_{g} {QDB}_{h}} \vert {φ}_{7} 〉 .$$

11. The quantum method of claim 10, wherein the removing the effect of the S operator also removes the effect of the S operator when it is not required to update the state of the qubits of the register |QDB [symbol] that define the criteria/conditions data for updating the data.

12. The quantum method of claim 9, wherein the applying the |j|+1 qubit Toffoli gates removes the effect of the applying the |M|+1-qubit Toffoli gate with |M| when it is not required to update the state of the qubits of the register QDB that define the criteria for updating the data.

13. The quantum method of claim 1, wherein the searching of the database data in register |QDB [symbol] includes defining the index of each qubit which its value is based on information in the set M that contain indices of qubits.

14. The quantum method of claim 13, wherein the searching of the database data in register |QDB [symbol] is based on applying the S operator between each qubit |qr_{g} [symbol] .

15. A device, comprising:
a quantum processor, wherein the quantum processor:
initializes four registers and two qubits in a quantum circuit;
searches database data in register |QDB [symbol] that matches criteria specified in register |qr [symbol] ;
applies an S operator;
applies |M|+1-qubit Toffoli gate with |M| control qubits of the register |QDB [symbol] ;
removes an effect of the controlled-S operator; and/or
applies a number 2*|j| of 3-qubit Toffoli gates;
updates marked data/records/basis states based on applying a number |j| of 3-qubit Toffoli gates;
applies |M|+2 qubit Toffoli gate; and
applies an effect of the controlled-S operator;
